(19) United States
(12) Patent Application Publication
(10) Pub. No.: US 2016/0283172 A1
(43) Pub. Date: Sep. 29, 2016

(54) IMAGE FORMING SYSTEM AND IMAGE FORMING APPARATUS

(71) Applicant: Oki Data Corporation, Tokyo (JP)

(72) Inventor: Jiani WANG, Tokyo (JP)

(21) Appl. No.: 14/972,543

(22) Filed: Dec. 17, 2015

(30) Foreign Application Priority Data
Mar. 26, 2015 (JP) 2015-065258

(51) Int. Cl. G06F 3/12; H04N 1/00; G06K 15/02; G06F 3/041; G06K 15/00

(52) U.S. Cl. CPC G06F 3/1228; G06F 3/1205; G06F 3/1258; G06F 3/041; G06F 3/1206; G06F 3/1287; G06K 15/005; G06K 15/1806; H04N 1/00204; H04N 2201/0094

(57) ABSTRACT

An image forming system includes an image forming apparatus and a host terminal connected to the image forming apparatus via a communication line. The image forming apparatus includes a receiving unit, a web page unit, a memory unit, a printing control unit, and a printing unit. The receiving unit receives printing data. The web page unit forms web page information for setting, for each identification information, printing setting information used for printing the printing data. The memory unit stores the printing setting information. The printing control unit controls printing of the printing data based on the printing setting information. The printing unit prints the printing data. The image forming apparatus is capable of printing without installing any printer driver on the side of the host terminal.

### CROSS-REFERENCE TO RELATED APPLICATIONS

This application claims priority benefits under 35 USC, section 119 on the basis of Japanese Patent Application No. 2015-065258, the disclosure of which is incorporated herein by reference.

### BACKGROUND OF THE INVENTION

1. Field of the Invention

This invention relates to an image forming system in which an image forming apparatus is connected in a way communicable with a host terminal and to the image forming apparatus.

2. Description of Related Art

In conventional image forming systems, a printer driver, as software, capable of setting printing corresponding to mage forming apparatuses such as printers, is generally installed in a host terminal such as, e.g., a personal computer, thereby storing the printing setting set by a user in the host terminal, and making printing upon outputting printing instructions to the image forming; apparatus from the host terminal. (see, e.g., Japanese Patent Application Publication 2015-007934 (A1))

With such conventional arts, there arises a problem that the image forming system is required to install such a printer driver to the host terminal for making printing at the image forming apparatus according to the host terminal.

### SUMMARY OF THE INVENTION

It is therefore an object of the invention to provide an image forming system allowing its image forming apparatus to print without any installation of a printer driver at its host terminal.

An image forming system according to, one aspect of the invention, includes an image forming apparatus and a host terminal connected to the image forming apparatus via a communication line. The image forming apparatus comprises a receiving unit for receiving printing data, a web page unit for forming web page information for setting, for each identification information, printing setting information used for printing the printing data, a memory unit for storing the printing setting information, a printing control unit for controlling printing of the printing data based on the printing setting information, and a printing unit for printing the printing data. The host terminal comprises a transmitting unit for transmitting the printing data to the image forming apparatus.

These and other objects, features, aspects and advantages of the disclosed disc brake caliper will become apparent to those skilled in the art from the following detailed description, which, taken in conjunction with the annexed drawings, discloses preferred embodiments.

### BRIEF DESCRIPTION OF THE DRAWINGS

Referring now to the attached drawings which form a part of this original disclosure:

FIG. 1 is a block diagram showing a structure of an image forming system according to an embodiment of the invention;

FIG. 2 is a flowchart showing a flow of printer's printing setting processing and printing processing according to the embodiment;

FIG. 3 is a flowchart showing a flow of new registration processing according to the embodiment;

FIG. 4 is an illustration showing an initial screen according to the embodiment;

FIG. 5 is an illustration showing a popup entry screen according to the embodiment;

FIG. 6 is an illustration showing a printer web page screen according to the embodiment;

FIG. 7 is an illustration showing an initial registration screen according to the embodiment;

FIG. 8 is an illustration showing a printer web page screen according to the embodiment; and

FIG. 9 is a flowchart showing a flow of printer's printing setting processing and printing processing according to a modified example.

### DETAILED DESCRIPTION OF THE EMBODIMENTS

Hereinafter, an embodiment according to the invention is described in detail with reference to the drawings.

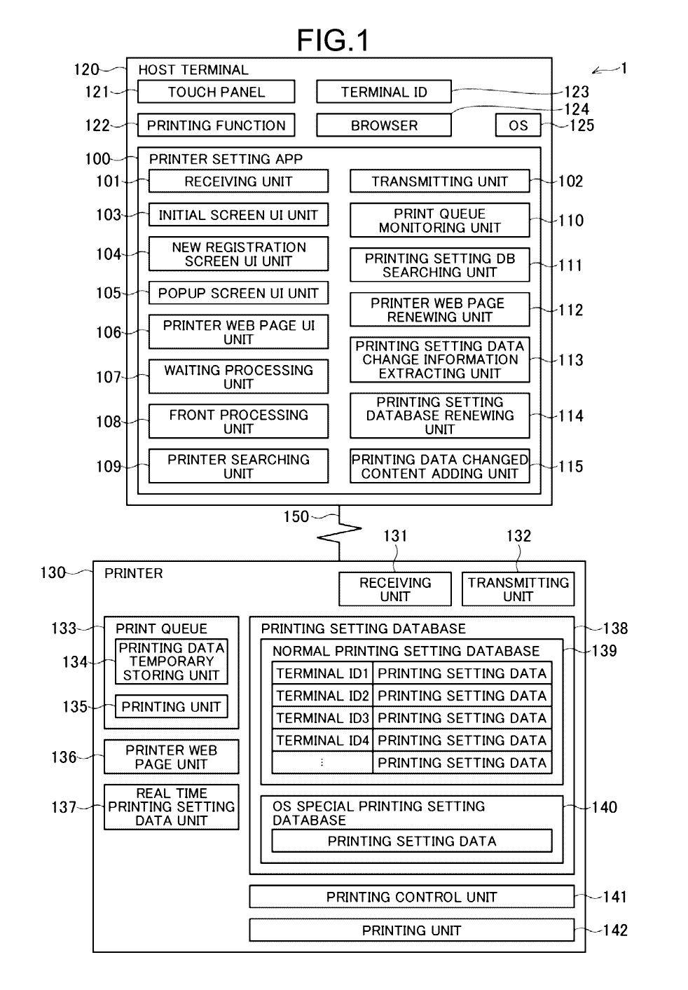

FIG. 1 is a block diagram showing a structure of an image forming system according to an embodiment of the invention. In FIG. 1, an image forming system 1 is structure of a host terminal 120 serving as an information processing terminal such as, e.g., one of computer terminals, or namely smart phones, and tablet terminals, and a printer 130 as an image forming apparatus, which are connected in a communicable way via a communication line 150 such as, e.g., the Internet, intranet such as Ethernet (registered trademark), and wireless connections such as Wi-Fi (registered trademark). The host terminal 120 transmits printing data for instructing printing operation to the printer 130, and the printer 130 makes printing of the printing data received from the host terminal 120 according to printing setting information, or namely, printing setting data.

It is to be noted that, in this embodiment, the system is described as that one host terminal 120 and one printer 130 are connected via the communication line 150, but the communication line 150 may connect two or more of the host terminals 120 with two or more of the printers 130. The host terminal 120 includes a touch panel 121, a printer setting application unit 100 formed from software, a printing function unit 122, a browser 124, an OS (Operating System) unit 125, and a terminal ID unit 123. The host terminal 120 has a controller such as, e.g., CPU (Central Processing Unit), and a memory unit such as a memory or memories, and the controller controls entire operations of the host terminal 120 based on a control program (software) stored in the memory unit.

The touch panel 121 includes a display portion such as, e.g., a panel type display device showing various kinds of information and an input portion formed corresponding to the display portion for receiving entry manipulations of a user. The printing function unit 122 is made from software executing printing at the printer 130 upon transmitting the printing data to the printer 130 based on the input manipulations. The browser 124 is made from software displaying web page information on the touch panel 121, for allowing the user to enter and change some items in the printer web page on the touch panel 121.

The OS unit 125 is made from software for managing the entire host terminal 120. The terminal ID unit 123 provides terminal ID information for identifying the host terminal 120 from other devices and also for identifying the user. In this embodiment, the user using the host terminal 120 is limited to one person, so that the terminal ID information becomes the identification information for identifying the user. Even where one host terminal 120 is used by plural users, the terminal ID information may be used as the user ID for identifying the user.

The printer setting application unit 100 is made from application software for setting printing of the printer 130, and includes a receiving unit 101, a transmitting unit 102, an initial screen UI (user interface) unit 103, a new registration screen UI unit 104, a popup screen UI unit 105, a printer web page UI unit 106, a waiting processing unit 107, a front processing unit 108, a printer searching unit 109, a printer queue monitoring unit 110, a printer setting database searching unit 111, a printer web page renewing unit 112, a printing setting data change information extracting unit 113, a printing setting database renewing unit 114, and a printing data changed content adding unit 115.

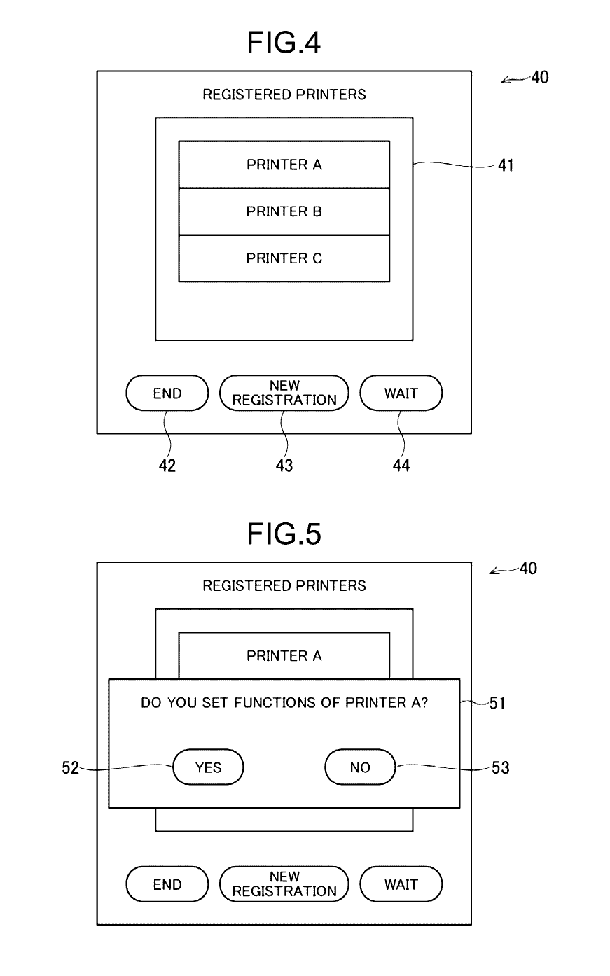

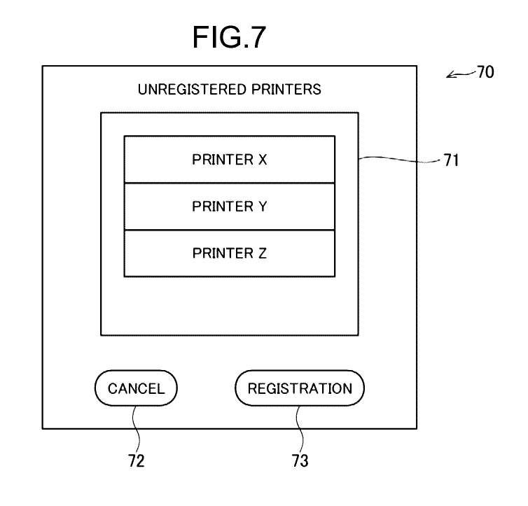

The receiving unit 101 receives data from the printer 130, whereas the transmitting unit 102 transmits data such as, e.g., the printing data to the printer 130. The initial screen UI unit 103 receives user's entry manipulations on an initial screen, e.g., an initial screen 40 shown in FIG. 4, displayed by the printer setting application unit 100 on the touch panel 121. The new registration screen UI unit 104 receives user's entry manipulations on a new registration screen such as, e.g. a new registration screen 70 shown in FIG. 7 for connecting the printer 130 connected via the communication line.

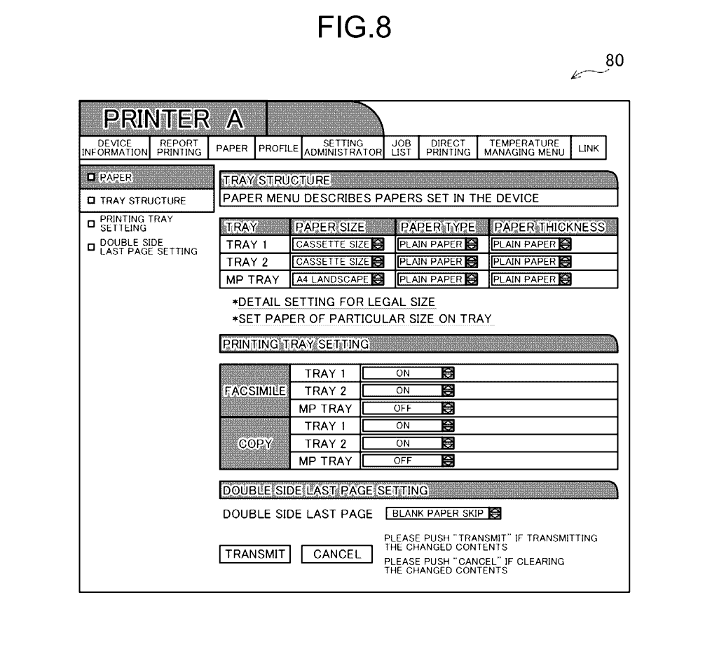

The popup screen UI unit 105 receives user's entry manipulations on a popup entry window such as, e.g., a popup entry window 51 shown in FIG. 5 for confirming the user whether to perform the printing setting of the printer. The printer web page UI unit 106 receives user's entry manipulations on a printer web page screen such as, e.g., a printer web page screen 80 shown in FIG. 8 for entering the printing setting of the printer. The waiting processing unit 107 allows the printer setting application unit 100 to execute as a background processing.

The front processing unit 108 displays a screen displayed by the printer setting application unit 100 on a topmost screen surface of the touch panel 121. The printer searching unit 109 searches printers connected to the communication line. The print queue monitoring unit 110 monitors the status of the print queue 133 of the printer 130. The printing setting database searching unit 111 searches information in a printing setting database 138 in the printer 130.

The printer web page renewing unit 112 renews contents of the printer web page unit 136 of the printer 130. The printing setting data change information extracting unit 113 compares real time printing setting data provided in a real time printing setting data unit 137 of the printer 130 with the printing setting data in the printing setting database 138, to extract different portions, or namely changed portions. The printing setting database renewing unit 114 renews the printing setting database 138 in the printer 130.

The printing data changed content adding unit 115 adds the changed contents of the printing setting data extracted at the printing setting data change information extracting unit 113 to the printing data stored in a printing data temporary storing unit 134. In this embodiment, the printing data are data instructing the printer 130 for printing and includes the identification information or terminal ID information in the terminal ID unit 123 of the host terminal 120, attribute information, change printer setting data, and the printing content data. The attribute information includes information instructing for doing a normal printing as well as information instructing for doing a particular OS printing. The change printer setting data are information of the changed contents of the printing setting data extracted at the printing setting data change information extracting unit 113. The printing content data are such as, e.g., drawing data to be printed on paper.

The printer 130 receives the printing data transmitted from the host terminal 120 and makes printing according to the received data. The printer 130 includes a receiving unit 131, a transmitting unit 132, the print queue 133, the printer web page unit 136, the real time printing setting data unit 137, the printing setting database 138, a printing control unit 141, and a printing unit 142. The printer 130 includes a controller such as, e.g., a CPU and a memory unit such as, e.g., a memory or memories, and the controller controls the entire operations of the printer 130 based on control programs (software) stored in the memory unit.

The receiving unit 131 receives the data such as, e.g., the printing data from the host terminal 120, and the transmitting unit 132 transmits the data to the host terminal 120. The print queue 133 temporarily stores printing jobs instructing printing, or namely made of an FIFO (first in first out) device, and includes the printing data temporary storing unit 134 for temporarily storing the printing data, and a printing function unit 135 functioning for printing. The printing data temporary storing unit 134 functions as temporarily storing the printing data of the received printing job without immediately printing. The printing function unit 135 provides a function or functions for printing when some data within a changing range are added to the printing data stored in the print queue 133.

The printer web page unit 136 provides web page information for printing setting of the printer 130, and the web page information includes a setting means for setting, for each identification information, the printing setting data used for making printing according to the printing data. The real time printing setting data unit 137 provides the real time printing setting data as third printing setting data, which are printing setting data set at the printer web page unit 136.

The printing setting database 138 serving as a memory unit stores the printing setting data, and functions as a database storing normal printing setting data as first printing setting data in a normal printing setting database 139 and OS special printing setting data as second printing setting data in an OS special printing setting database 140. The normal printing setting database 139 stores at least one printing setting data in association with the terminal ID information given as identification information by the terminal ID unit 123 of the host terminal 120; the OS special printing setting database 140 stores the printing setting data where the OS special printing is made. It is to be noted that the instructions as to whether printing is done with the printing setting data of the normal printing setting database 139 or the OS special printing setting database 140, are made according to the attribute information in a header section of the printing data sent from the host terminal 120.

FIG. 1 illustrates the image forming system 1 having only one host terminal 120, but as described above the image forming system 1 may include a plural number of the host terminals 120, each of which is identified with the respective terminal ID information. In other words, the punter 130 is connectable to the plural host terminals 120 such as, e.g., computer terminals, smart phones, and tablet terminals. The normal printing setting database 139 stores each of the terminal ID information in association with the printing setting data, respectively.

In this embodiment, the identification information in the normal printing setting database 139 is described as having terminal ID information for identifying each of the host terminals 120, and the terminal ID information may also be used as user ID information for identifying the users. Accordingly, the normal printing setting database 139 stores the printing setting data for every host terminals or every users. The printing control unit 141 controls printing operation of the printing data according to the printing setting data. The printing unit 142 does printing of the printing data on paper according to the control of the printing control unit 141.

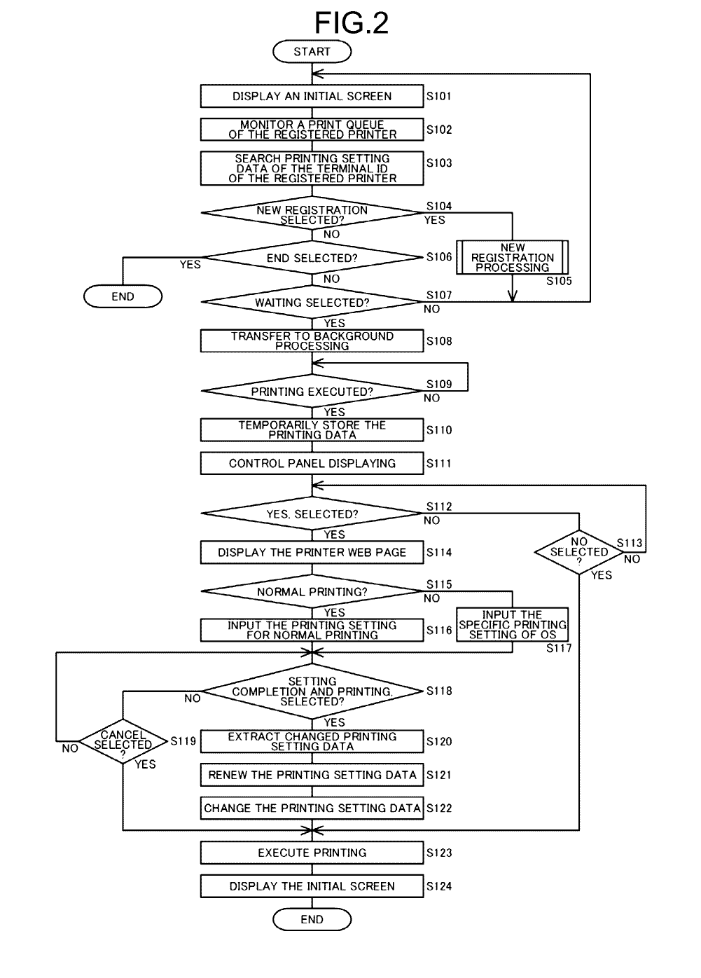

In operation, the printing setting processing and the printing processing done with the image forming system 1 are described in reference with steps shown with “S” in the flowchart in FIG. 2 and in reference with FIG. 1. It is presumed that the host terminal 120 receiving user's manipulations is connected with the printer 130 for making printing upon reception of the printing jobs from the host terminal 120 via the communication line 150 in a communicable way, and that the printer setting application unit 100 is preinstalled in the host terminal 120.

Where the printer setting application unit 100 of the host terminal 120 is activated, the printer setting application unit 100 displays an initial screen on the touch panel 121 according to the initial screen UI unit 103 at Step S101. The initial screen is, for example, an initial screen 40 shown in FIG. 4 on the side of the host terminal 120, including a set 41 of registered printers listing names of the printers connected to the communication line 150 and registered in the printer setting database 138, an end button 42 for ending the activation of the printer setting application unit 100, a new registration button 43 for newly registering a printer, and a waiting button 44 executing the printer setting application unit 100 on the background.

The print queue monitoring unit 110 in the printer setting application unit 100 begins a processing monitoring the print queue 133 in the registered printer 130 at Step S102. The printing setting database searching unit 111 in the printer setting application unit 100 begins a processing searching the printing setting data stored in the printing setting database 138 of the registered printer 130 based on the terminal ID information in the terminal ID unit 123 of the host terminal 120 at Step S103.

If the initial screen UI unit 103 detects a selection of “the new registration” as a manipulation on the initial screen for newly registering a printer, i.e., pushing the new registration button 43 on the initial screen 40 shown in FIG. 4, the processing goes to Step S105, and if “the new registration” is not selected, the processing proceeds to Step S106. At Step S105, the printer setting application unit 100 performs the new registration processing of the printer if the initial screen UI unit 103 detects the selection of “the new registration,” and renders the processing move to Step S101. Details of the new registration processing are described below.

Where “the new registration is not selected at Step S104, if the initial screen UI unit 103 at Step S106 detects a selection of the “end” as a manipulation ending the activation of the printer setting application unit 100 on the initial screen, or namely pushing the end button 42 on the initial screen 40 shown in FIG. 4, this processing is ended. If the “end” is not selected, the processing goes to Step S107. Where the “end” is not selected at Step S106, if the initial screen UI unit 103 at Step S107 detects, on the initial screen, the selection of the “wait” as a manipulation rendering the printer setting application unit 100 execute on the background, or namely pushing the waiting button 44 on the initial screen 40 as shown in FIG. 4, the processing proceeds to Step S108. If the “wait” is not selected, the processing goes to Step S101.

The printer setting application unit 100 detecting the selection of the “wait” on the initial screen makes the processing go to the background processing with the waiting processing unit 107 at Step S108. In the host terminal 120 in which the printer setting application unit 100 proceeds to the background processing, the browser 124 is activated according to the manipulation of the user at Step S109, and the printing function unit 122 provides an instruction for making printing of the normal printing or the OS special printing. The host terminal 120 then waits for execution of the printing upon designating the printer 130, and transmits the printing data to the printer 130 when the printing is executed, thereby rendering the processing proceed to Step S110. It is to be noted that the instruction information for making the normal printing or the OS special printing is added to the header section of the printing data as an attribute or attribute information.

The printer 130 temporarily stores the received printing data in the print queue 133 at Step 110 when receiving the printing data transmitted from the host terminal 120. On the other hand, the host terminal 120 at Step S111 displays a popup entry screen of the printer setting application unit 100 on the touch panel 121 according to the front processing unit 108 and the popup screen UI unit 105. The entry screen is, e.g., the popup entry window 51 as shown in FIG. 5, and includes a message such as “Do you set functions of Printer A?,” a “YES” button 52 designating setting functions, and a “NO” button 53 designating not setting functions.

If the popup screen UI unit 105 at Step S112 detects the selection of “YES” instructing setting functions on the popup entry window, or namely pushing the “YES” button 52 on the popup entry window 51 shown in FIG. 5, the processing is proceeded to Step S114. If “YES” is not selected, the processing goes to Step S113. Where “YES” is not selected at Step S112, if the popup screen UI unit 105 at Step S113 detects the selection of “NO” instructing not setting any function on the popup entry window, or namely pushing the “NO” button 53 on the popup entry window 51 shown in FIG. 5, the processing goes to Step S123. If the “NO” is not selected, the processing goes to Step S112.

If “YES” is selected at Step S112 for instructing setting functions on the popup entry window, the printer setting application unit 100 provides an inquiry to the printer 130 with the printer web page UI unit 106, reads out the printer web page data from the printer web page unit 136 stored in the printer 130, and, at step S114, displays the printer web page on the touch panel 121 based on the printer web page data.

The printer setting application unit 100 further transmits to the printer 130 a notice requesting the printing setting data including the terminal identification information (terminal ID) with the printing setting database searching unit 111, and the printer 130 receiving the notice searches the normal printing setting database 139 of the printing setting database 138 based on the terminal identification information to extract the printing setting data from the normal printing setting database 139 corresponding to the terminal identification information of the host terminal 120, thereby returning the data to the host terminal 120. The printer setting application unit 100 judges at Step S115 as to whether the normal printing is instructed at Step S109, and if it is judged that the normal printing is instructed, the processing goes to Step S116, while if it is judged that the OS specific printing is instructed, the processing goes to Step S117.

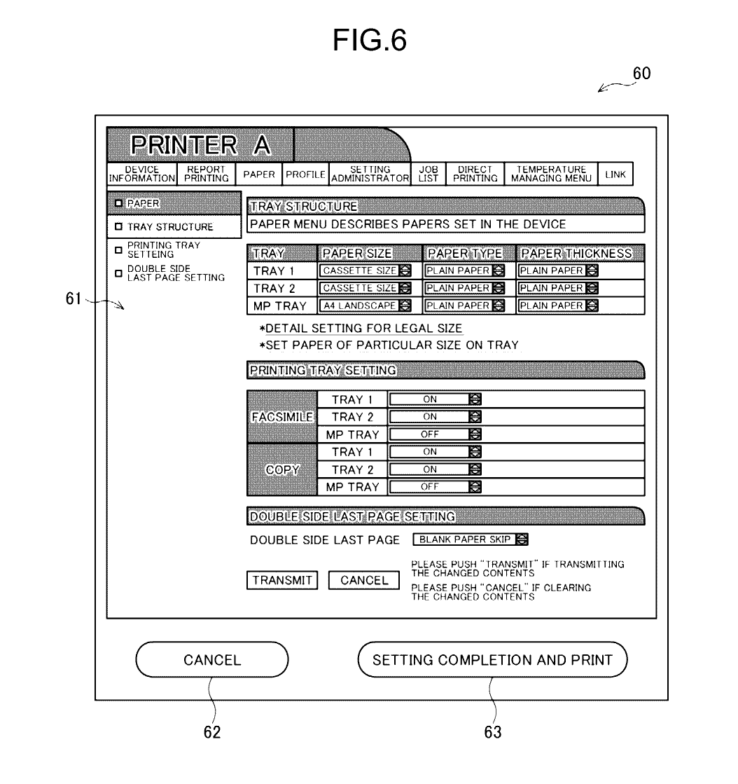

The printer setting application unit 100 judging as the normal printing is instructed, displays at Step S116 on the touch panel 121 the printer web page reflecting the printing setting data of the normal printing setting database 139. The printer web page formed at the printer web page unit 136 is sent from the printer 130 to the host terminal 120, and is displayed in association with the printer web page UI unit 106. The printer web page is such as, e.g., a printer web page 60 shown in FIG. 6, and includes a display and entry region 61 of the printing setting data made from various setting items and setting values corresponding to those setting items, a “cancel” button 62 stopping setting of functions, and a “setting completion and print” button 63 for completing the function settings and making printing based on the given printing setting data. The display and entry region 61 is formed of display portions, setting and changing portions. The entries of setting or changing of the various setting items can be done with manipulations of the display and entry region 61. Such entries and changes of setting items will be sent back to the printer 130.

That is, the printer setting application unit 100 receives entries of setting or changing of the various setting items and the setting values corresponding to the setting items as function settings via the printer web page in association with the printer web page UI unit 106, and renews the printing setting data based on the set or changed setting values in association with the printer web page renewing unit 112, thereby rendering the processing go to Step S118.

To the contrary, the printer setting application unit 100 judging as the OS special printing is instructed, displays at Step S117 on the touch panel 121 the printer web page reflecting the printing setting data of the OS special printing setting database 140 received from the printer 130 in association with the printer web page UI unit 106. The printer web page is, e.g., the printer web page 60 shown in FIG. 6 as described above.

The printer setting application unit 100 receives entries of setting or changing of the various setting items and the setting values corresponding to the setting items as function settings via the printer web page in association with the printer web page UI unit 106, and renews the printing setting data based on the set or changed setting values in association with the printer web page renewing unit 112, thereby rendering the processing go to Step S118.

With this embodiment, using the printer web page 60 allows setting of the printing setting data for the normal printing and the OS special printing corresponding to the attribute information of the printing data. The printer web page 60 displays, at the display and entry region 61 for the printing setting data serving as the display unit, the attribute information of the printing data, and the printing setting data of the normal printing setting database 139 or the printing setting data of the OS special printing setting database 140, corresponding to the printing setting data stored in the printing setting data in the printing setting database 138,

If the printer web page UI unit 106 at Step S118 detects that “setting completion and print” for completing the function settings and printing based on the set or changed printing setting data, is selected, or namely pushing the “setting completion and print” button 63 of the printer web page 60 shown in FIG. 6, the processing goes to Step S120. If the “setting completion and print” is not selected, the processing goes to Step S119.

Where the “setting completion and print” is not selected at Step S118, if the printer web page UI unit 106 detects at Step S119 that the “cancel” stopping the function setting on the printer web page is selected, or namely pushing the “cancel” button 62 of the printer web page 60 as shown in FIG. 6, the processing goes to Step S123. If the “cancel” is not selected, the processing goes to Step S118.

If the “setting completion and print” for completing the function setting and printing based on the set or changed printing setting data is selected at Step S118 on the printer web page, the printer setting application unit 100 extracts the set or changed printing setting data in association with the printing setting data change information extracting unit 113 at Step S120.

The printer setting application unit 100 extracting the set or changed printing setting data, at Step S121 transmits the received terminal ID information and the extracted printing setting data to the printer 130 in association with the printing setting database renewing unit 114. The printer 130 renews, corresponding to the received terminal ID information, the printing setting data stored in the printing setting database 138 based on the received terminal ID information and the printing setting data.

The printer setting application unit 100 at Step S122 adds, to the printing data, the changed contents of the printing setting data as the changed printing setting data based on the printing setting data set or changed at Step S114 in association with the printing data changed content adding unit 115. The host terminal 120 transmits the printing data to the printer 130 at Step S123. The printer 130 makes printing based on the received printing data.

The printer 130 herein analyzes the printing data received from the host terminal 120 with the printing control unit 141, renews the printing setting data in the normal printing setting database 139 corresponding to the ID information of the host terminal 120 contained in the printing data, based on the changed printing setting data contained in the printing data in a case where the attribute of the header section of the printing data is the normal printing, and makes printing based on the renewed printing data.

The printer 130 herein analyzes the printing data received from the host terminal 120 with the printing control unit 141, renews the printing setting data in the OS special printing setting database 140 corresponding to the ID information of the host terminal 120 contained in the printing data, based on the changed printing setting data contained in the printing data in a case where the attribute of the header section of the printing data is the OS special printing, and makes printing based on the renewed printing data.

It is to be noted that, where there is no change in the printing setting data of the normal printing setting database 139 or in the printing setting data of the OS special printing setting database 140, printing is made based on the printing setting data in the normal printing setting database 139 or the printing setting data in the OS special printing setting database 140, stored in the printing setting database 138 of the printer 130, without renewing any printing setting data.

The printing control unit 141 of the printer 130 thus controls printing of the printing data based on the attribute information attached to the printing data and the printing setting data stored in the printing setting database 138. The printing control unit 141 controls printing of the printing data based on the printing setting data selected with the printer web page. The printing control unit 141 controls printing of the printing data based on the printing setting data changed with the printer web page.

The printer setting application unit 100 of the host terminal 120 displays at Step S124 the initial screen on the touch panel 121 in association with the initial screen UI unit 103 and ends this processing.

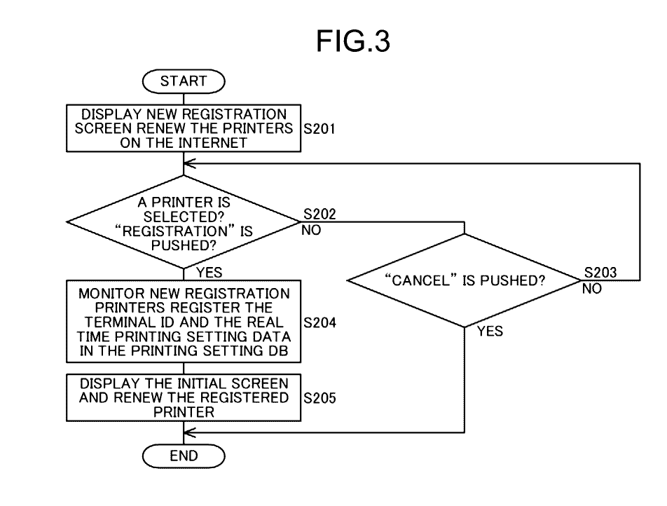

Next, a new registration processing of the printer done by the image forming system is described along steps in a flowchart showing a flow of the new registration processing of the embodiment shown in FIG. 3, in reference with FIG. 1.

The printer setting application unit 100 displays a new registration screen of the printer on the touch panel 121 in association with the new registration screen UI unit 104. The new registration screen is such as, e.g., a new registration screen 70 shown in FIG. 7, and includes a printer portion 71 connected on the communication line 150 for listing printer names of the unregistered printers connected to the communication line 150, a cancel button 72 for ending the new registration processing, and a registration button 73 for newly registering the selected printer. The new registration screen UI unit 104 monitors the printers connected to the communication line 150 with the printer searching unit 109 while displaying the new registration screen, and renews printers connected to the communication line and displayed on the new registration screen 70.

The new registration screen UI unit 104 at Step S202 detects that the printer selection manipulation of the printers displayed on the new registration screen is completed, and that “registration” for newly registering one of the printers is selected, or namely, pushing the “registration button” 73 on the new registration screen 70 shown in FIG. 7, the processing goes to Step S204. If “registration” is not chosen, the processing goes to Step S203. At Step S118 shown in FIG. 2, where “registration” is not selected, if the new registration screen UI unit 104 at Step S203 detects “cancel” for ending the new registration processing, or namely pushing the “cancel” button 72 on the new registration screen 70 shown in FIG. 7, this processing is ended. If “cancel” is not selected, the processing goes to Step S202.

The print queue monitoring unit 110 of the printer setting application unit 100 at Step S204 monitors the print queue 133 of the newly registered printer 130, and notifies the terminal ID information and an instruction for registering the real time printing setting data to the printer 130. The printer 130 receiving the notice stores the real time printing setting data in the printing setting database 138 based on the received terminal ID information in association with the real time printing setting data unit 137 and registers the real time printing setting data. The printer setting application unit 100 displays the initial screen of the newly registered printer as the registered printer on the touch panel 121 in association with the initial screen UI unit 103, and ends this processing.

According to this embodiment, the printer 130 of the image forming system 1 includes the receiving unit 131 for receiving the printing data, the printer web page unit 136 having the setting means for setting, for each identification information, the printing setting data used for making printing according, to the printing data, the printing setting database 138 storing the printing setting data thus set, the printing control unit 141 controlling printing of the printing data based on the printing setting data, and the printing unit 142 for printing the printing data according to control of the printing control unit 141, thereby allowing the user printing without installing any driver printer of the printer 130 in the host terminal 120.

In this embodiment, function settings of the printer 130 can be done at Step S110 shown in FIG. 2 while the printing data are temporarily stored on the side of the printer 130, because the printing data transmitted from the host terminal 120 are temporarily stored in the printer queue 133 on the side of the printer 130. When printing operation is executed at the host terminal 120, the printing data transmitted from the host terminal 120 are temporarily stored in the printer queue 133 on the side of the printer 130, and as a modified example, the printing data may be stored temporarily on the side of the printer 130 after the function setting at the host terminal is instructed.

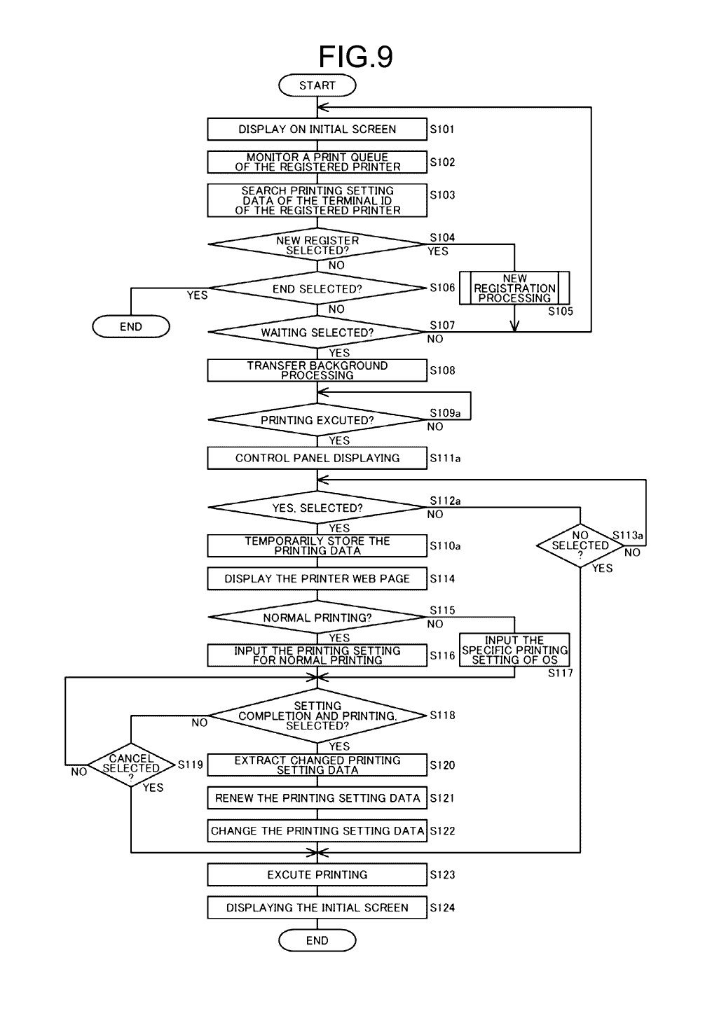

Such a modified example is described in reference with Steps S109a, S111a, S112a, S113a, S110a in FIG. 9. The processing shown as Steps S101 to S108, and S114 to S124 are substantially the same as those in FIG. 2, and for the sake of brevity, duplicated explanation is omitted.

The host terminal 120 in which the printer setting application unit 100 shifts to the background processing, at Step S109a begins operation of the browser 124 according to user's manipulation, and waits for the, instruction of either of the normal printing or the OS special printing according to the printing function unit 122 and for execution of printing upon designating the printer 130. When the printing is executed, the processing goes to Step S111a.

When the printing is executed at Step S109a, the host terminal 120 displays a popup entry screen of the printer setting application unit 100 on the touch panel 121 in association with the front processing unit 108 and the popup screen UI unit 105 of the printer setting application unit 100. If the popup screen UI unit 105 at Step S112a detects the selection of “YES” instructing the function setting on the popup entry screen, the host terminal 120 transmits the printing data to the printer 130, and the processing goes to Step S110a. If “YES” is not selected, the processing goes to Step S113a. It is to be noted that the instruction information as to whether the normal printing or the OS special printing is to be done is added to the header section of the printing data as the attribute.

Where “YES” is not selected at Step S112a, if the popup screen UI unit 105 detects the selection of “NO” instructing not performing the function setting on the popup entry screen, the host terminal 120 transmits the printing data to the printer 130, and the processing goes to Step S123. If “NO” is not selected, the processing goes to Step S112a. The printer 130 temporarily stores the received printing data to the printing queue 133 when receiving the printing data transmitted from the host terminal 120.

As described above, where the function setting is made at Step S112a after it is confirmed as to whether the function setting of the printer is made, the use capacity of the print queue 133 can be reduced because the printer 130 temporarily stores the printing data in the print queue 133 at Step S110a while the function setting is done where the function setting is made and because the printer 130 does not temporarily store the printing data in the print queue 133 at Step S110a where the function setting is not made.

Although the printing data are held in the print queue 133 for a prescribed time even where the function setting is not made, the time can be shorter in comparison with a time where the data are temporarily stored in the print queue 133 at Step S110a. As described above, with the embodiment, it is advantageous to make printing with the printer as the image forming apparatus without installing any printer driver in the host terminal.

The user displays the web page of the printer on the host terminal, and can advantageously enter the printing setting data, thereby setting the function of the printer. With the image forming system, the printing setting data can be set to the printer for each user, so that the user utilizes the previously set printing setting data as they are, thereby making user's usability much improved.

Although in this embodiment the image forming apparatus is described as a printer, the image forming apparatus is not limited to this and can be such as, multifunction peripherals (MFPs). Although in this embodiment, it is described in which the printer setting application unit 100 is installed in the host terminal, the invention is not limited to this structure, but a variety of software may have a function of the printer setting application unit 100. The printer setting application unit 100 may be distributable to the users as independent software.

While only selected embodiments have been chosen to illustrate this invention, it will be apparent to those skilled in the art from this disclosure that various changes and modifications can be made herein without departing from the scope of the invention as defined in the appended claims. Furthermore, the foregoing descriptions of the embodiments according to this invention are provided for illustration only, and not for the purpose of limiting the invention as defined by the appended claims and their equivalents.

What is claimed is:

1. An image forming system having an image forming apparatus and a host terminal connected to the image forming apparatus via a communication line,
the image forming apparatus comprising:
a receiving unit for receiving printing data;
a web page unit for forming web page information for setting, for each identification information, printing setting information used for printing the printing data;
a memory unit for storing the printing setting information;
a printing control unit for controlling printing of the printing data based on the printing setting information; and
a printing unit for printing the printing data, and
the host terminal comprising a transmitting unit for transmitting the printing data to the image forming apparatus.

2. The image forming system according to claim 1, wherein the printing setting information is set according to attribute information of the printing data, and wherein the printing control unit controls printing of the printing data based on the attribute information attached to the printing data and based on the printing setting information stored in the memory unit.

3. The image forming system according to claim 2, wherein the web page information includes corresponding printing setting information to be displayed, the corresponding printing setting information being formed based on the received attribute information and on the stored printing setting information in the memory unit.

4. The image forming system according to claim 2, wherein the web page information further includes the printing setting information to be changed, while the printing setting information formed based on the received attribute information and based on the stored printing setting information in the memory unit is displayed.

5. The image forming system according to claim 3, wherein the host terminal further comprises a display unit for displaying the web page information transmitted from the image forming apparatus to the host terminal.

6. The image forming system according to claim 5, wherein the display unit displays the web page information according to operation of a web browser.

7. The image forming system according to claim 5, wherein the display unit has a touch panel function for inputting information selected by the user.
touch panel function for inputting information selected by the user.

8. The image forming system according to claim 1, wherein the web page unit sets the printing setting information at each user.

9. The image forming system according to claim 1, wherein the image forming apparatus temporarily stores the printing data transmitted from the host terminal while the printing setting information is set.

10. The image forming system according to claim 1, wherein the memory unit stores plural combinations of the printing setting information and the attribute information in a form of a database.

11. The image forming system according to claim 1, wherein the attribute information includes an instruction for the printing control unit as to whether making printing with a normal mode or a particular OS mode.

12. An image forming apparatus connectable via a communication line to a host terminal having a transmitting unit tor transmitting printing data, the image forming apparatus comprising:
a receiving unit for receiving the printing data;
a web page unit for forming web page information for setting, for each identification information, printing setting information used for printing the printing data;
a memory unit for storing the printing setting information;
a printing control unit for controlling printing of the printing data based on the printing setting information; and
a printing unit for printing the printing data.

13. The image forming apparatus according to claim 12, wherein the printing setting information is set according to attribute information of the printing data, and wherein the printing control unit controls printing of the printing data based on the attribute information attached to the printing data and on the printing setting information stored in the memory unit.

14. The image forming apparatus according to claim 13, wherein the web page information includes corresponding printing setting information to be displayed, the corresponding printing setting information being formed based on the received attribute information and on the stored printing setting information in the memory unit.

15. The image forming apparatus according to claim 13, wherein the web page information further includes the printing setting information to be changed, while the printing setting information formed based on the received attribute information and on the stored printing setting information in the memory unit is displayed.
